(19) United States
(12) Patent Application Publication
(10) Pub. No.: US 2006/0088344 A1
(43) Pub. Date: Apr. 27, 2006

(54) Image forming device

(75) Inventor: Kiyofumi Aikawa, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/141,008

(22) Filed: Jun. 1, 2005

(30) Foreign Application Priority Data
Oct. 26, 2004 (JP) 2004-311087

(51) Int. Cl. G03G 15/01

(52) U.S. Cl. 399/301

(57) ABSTRACT

Electrostatic latent images of a pattern image and an original image are formed on each of a plurality of image carriers. Each image carrier is provided with a developing unit and a transfer unit, and images of a reference color and colors other than the reference color are formed on a continuous sheet of paper. Detectors that detect the pattern images on the continuous sheet are disposed at conveying direction downstream sides of image carriers, and positional offset amounts of the pattern images of the colors other than the reference color are computed. On the basis of a detection of the pattern image of the reference color, a start position of electrostatic latent image formation at each image carrier is determined. Further, the start position is corrected on the basis of a positional offset amount computed at a time of transferring a preceding pattern image.

### CROSS-REFERENCE TO RELATED APPLICATION

This application claims priority under 35 USC 119 from Japanese Patent Application No. 2004-311087, the disclosure of which is incorporated by reference herein.

### BACKGROUND OF THE INVENTION

1. Field of the Invention

The present invention relates to an image forming device, and in particular, to an image forming device which forms images on a continuous sheet of paper or an uncut sheet of paper.

2. Description of the Related Art

As a conventional image forming device, there is known a tandem-type image forming device in which toner images of plural colors such as yellow, magenta, cyan, black, and the like are formed respectively on plural image carriers which are lined-up along the conveying path of a continuous sheet of paper, and the color toner images formed on the respective image carriers are transferred, in a superposed manner, onto a continuous sheet of paper which is being conveyed, so as to form an image on the continuous sheet of paper. In such an image forming device, electrostatic latent images are formed on the respective image carriers by carrying out exposure corresponding to an original image. By developing these electrostatic latent images by developing materials of respectively different colors, the toner images of the respective colors are formed on the image carriers. When the toner images, which are formed on the image carriers, reach the positions of transfer rollers which are for transferring the toner images onto the continuous sheet of paper, the toner images are successively transferred onto the continuous sheet of paper. In this way, color images based on the original image are formed in a superposed manner on the continuous sheet of paper.

In such an image forming device, there is known a technique of detecting the positional offset amounts between the images formed on the continuous sheet of paper, and correcting the positional offsets between the images on the basis of the detected positional offset amounts (see, for example, Japanese Patent Application Laid-Open (JP-A) No. 2001-272837 (FIG. 1 and pages 5-6).

In accordance with the technique disclosed in JP-A No. 2001-272837, pattern images of respective colors are formed on a continuous sheet of paper by a plurality of image carriers respectively. A sensor for pattern reading, which is for sensing the pattern images, is disposed at the downstream side of the image carrier which is disposed furthest downstream in the conveying direction of the continuous sheet of paper among the plural image carriers. The color pattern images formed on the continuous sheet of paper are detected by the sensor. On the basis of the results of detection, positional offset amounts of the pattern images are determined, and the formation timings, at which formation of the electrostatic latent images onto the image carriers begins, are controlled. In this way, the positional offsets among the respective color images can be corrected.

In the above-described related art, the timings for starting formation of the electrostatic latent images onto the image carriers can be adjusted on the basis of the results of sensing the formed color pattern images. However, until the pattern images are sensed, and the correction amounts are computed on the basis of the sensed results, and exposure, in which the electrostatic latent image formation start timings are corrected on the basis of the correction amounts, is actually carried out, there is the problem that positional offset arises due to elongation of the continuous sheet of paper, fluctuations in the conveying speed of the continuous sheet of paper, and the like.

### SUMMARY OF THE INVENTION

The present invention was developed in order to overcome the above-described drawback, and an object of the present invention provides an image forming device which can correct positional offset among images with high accuracy.

An image forming device of a first aspect of the present invention includes: a plurality of image carriers lined-up along a conveying direction of a continuous sheet of paper which is conveyed; a plurality of latent image forming units forming electrostatic latent images of images, which include a pattern image and an original image, on the image carriers; a plurality of developing units developing the electrostatic latent images formed on the image carriers, by developing materials of different colors; a plurality of transfer units transferring images of different colors, which have been developed at the developing units, onto the continuous sheet of paper; a plurality of detectors disposed at conveying direction downstream sides of the image carriers respectively, and detecting the pattern images of the different colors which have been transferred by the transfer units; a computer which, by using as a reference color the color of the developing material which develops one of the pattern images detected by the detectors, computes positional offset amounts of pattern images developed in colors other than the reference color; and a controller which, on the basis of timings at which the pattern images are detected by the detectors which are positioned at conveying direction upstream sides of the image carriers respectively, determines electrostatic latent image formation start positions, on the image carriers, of the original images, and which, on the basis of positional offset amounts computed when transferring pattern images a previous time, corrects the electrostatic latent image formation start positions, and which controls the latent image forming units such that the electrostatic latent images of the original images are formed on the image carriers from corrected electrostatic latent image formation start positions.

### BRIEF DESCRIPTION OF THE DRAWINGS

An embodiment of the present invention will be described in detail based on the following figures, wherein:

FIG. 1 is a schematic structural diagram of an image forming device of the present invention;

FIG. 2 is a schematic diagram showing the electrical structure of the image forming device of the present invention;

FIG. 3 is a schematic diagram showing respective color pattern images formed on a continuous sheet of paper;

FIGS. 4A and 4B are a flowchart showing the flow of processings executed at a control section of the image forming device of the present invention; and

FIGS. 5A through 5D are schematic diagrams showing pattern images of respective colors and original images of respective colors which are formed on the continuous sheet of paper due to the continuous sheet of paper being conveyed, where FIG. 5A is a schematic diagram showing a state of the continuous sheet of paper after an original image and a pattern image have been formed by a printing section 12Y which is disposed the furthest upstream in a conveying direction of the continuous sheet of paper, FIG. 5B is a schematic diagram showing a state of the continuous sheet of paper after an original image and a pattern image have been formed by a printing section 12M which is disposed adjacent to and at the conveying direction downstream side of the printing section 12Y which is disposed the furthest upstream in the conveying direction of the continuous sheet of paper, FIG. 5C is a schematic diagram showing a state of the continuous sheet of paper after an original image and a pattern image have been formed by a printing section 12C which is disposed adjacent to and at the conveying direction downstream side of the printing section 12M, and FIG. 5D is a schematic diagram showing a state of the continuous sheet of paper after an original image and a pattern image have been formed by a printing section 12C which is disposed adjacent to and at the conveying direction downstream side of the printing section 12K.

### DETAILED DESCRIPTION OF THE INVENTION

An embodiment of the present invention will be described hereinafter with reference to the drawings.

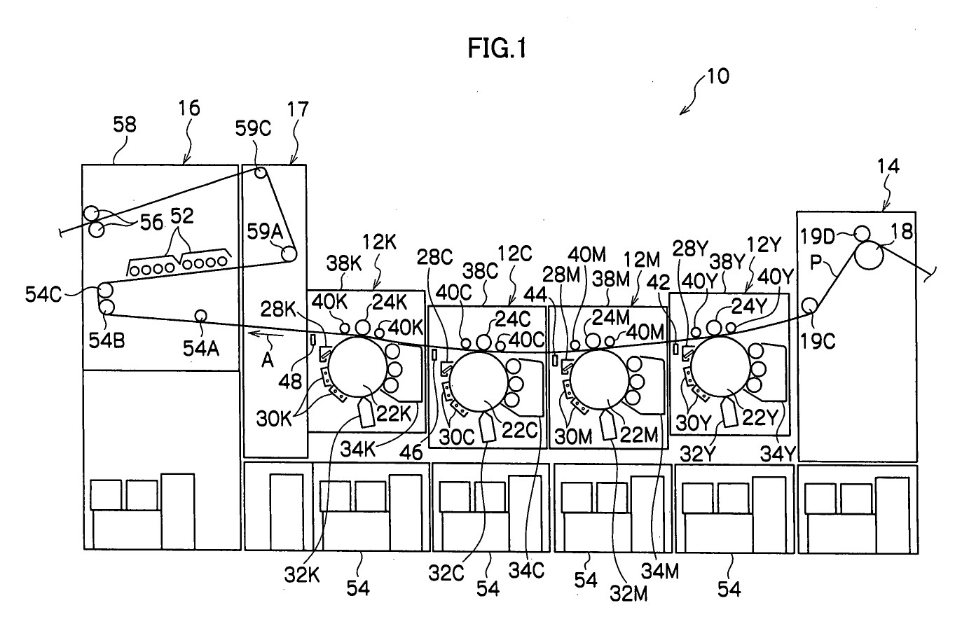

As shown in FIG. 1, an image forming device 10 has four image printing units which successively transfer color toner images of yellow (Y), magenta (M), cyan (C), and black (K) onto a continuous sheet of paper P, i.e., a printing section 12Y, a printing section 12M, a printing section 12C, and a printing section 12K. The printing section 12Y, the printing section 12M, the printing section 12C, and the printing section 12K are lined-up in that order from the upstream side toward the downstream side in the conveying direction of the continuous sheet of paper P. A sheet supplying section 14, which conveys the continuous sheet of paper P to the printing section 12Y, the printing section 12M, the printing section 12C, and the printing section 12K, is provided at the conveying direction upstream side of the printing section 12Y. A fixing section 16 and a sheet discharging section 17 are provided at the conveying direction downstream side of the printing section 12K. The fixing section 16 fixes, to the continuous sheet of paper P, the respective color toner images which were transferred at the printing section 12Y, the printing section 12M, the printing section 12C, and the printing section 12K. The sheet discharging section 17 discharges the continuous sheet of paper P which has passed through the fixing section 16.

The sheet feeding section 14 has a conveying roller 18 around which the continuous sheet of paper P is trained. An idle roller 19D press-contacts the conveying roller 18. The continuous sheet of paper P is nipped and conveyed by the nip portion between the idle roller 19D and the conveying roller 18, and is conveyed to the printing section 12Y via the idle roller 19C.

The printing section 12Y, the printing section 12M, the printing section 12C, and the printing section 12K have an image carrier 22Y, an image carrier 22M, an image carrier 22C, and an image carrier 22K, respectively. The image carrier 22Y, the image carrier 22M, the image carrier 22C, and the image carrier 22K are lined-up along the conveying path of the continuous sheet of paper P.

The printing section 12Y also has a transfer roller 24Y, guide rollers 40Y, a cleaning device 28Y, an charger 30Y serving as a transfer unit, an LED head 32Y serving as a latent image forming unit, and a developing device 34Y. The charger 30Y uniformly charges the image carrier 22Y. For example, the charger 30Y applies a negative voltage in which a negative DC bias voltage is superimposed on an AC voltage. The LED head 32Y forms an electrostatic latent image on the image carrier 22Y by exposing the image carrier 22Y, which is uniformly charged by the charger 30Y, on the basis of image data of an original image, i.e., a main image, which expresses the image which is to be printed and which corresponds to the Y color, and image data of a pattern image which is applied in order to detect positional offset. The developing device 34Y is provided at the downstream side, in the direction of rotation of the image carrier, of the LED head 32Y (the image carrier 22Y rotates counterclockwise in FIG. 1), and forms a Y color toner image corresponding to the electrostatic latent image formed on the image carrier 22Y. A negative developing bias voltage, in which a negative DC bias voltage is superimposed on an AC voltage, is applied to the developing device 34Y. Due to the Y color toner being adsorbed by the developing device 34Y only at the region where the electrostatic latent image is formed on the image carrier 22Y, a toner image, which corresponds to the electrostatic latent image and is formed from Y color toner particles which are charged negative, is formed on the image carrier 22Y.

Due to the transfer roller 24Y applying a transfer bias to the Y color toner image formed on the image carrier 22Y by the developing device 34Y, the toner image, which is formed from toner particles which are charged negative, is attracted from the image carrier 22Y toward the continuous sheet of paper P, and the toner image is transferred onto the continuous sheet of paper P. The cleaning device 28Y scrapes-off and removes the un-transferred, residual toner which was not transferred to the continuous sheet of paper P and remains on the surface of the image carrier 22Y.

In the same way as the printing section 12Y, the printing section 12M also has an image carrier 22M, a transfer roller 24M, guide rollers 40M, a cleaning device 28M, an charger 30M, an LED head 32M, and a developing device 34M. Further, in the same way as the printing section 12Y, the printing section 12C also has an image carrier 22C, a transfer roller 24C, guide rollers 40C, a cleaning device 28C, an charger 30C, an LED head 32C, and a developing device 34C. Moreover, in the same way as the printing section 12Y, the printing section 12K also has an image carrier 22K, a transfer roller 24K, guide rollers 40K, a cleaning device 28K, an charger 30K, an LED head 32K, and a developing device 34K. The respective structures of the printing section 12M, the printing section 12C, and the printing section 12K have similar functions as those of the above-described printing section 12Y, and therefore, detailed description thereof is omitted.

The color toner images are successively transferred onto the continuous sheet of paper by the printing section 12Y, the printing section 12M, the printing section 12C and the printing section 12K, such that color images, which are based on the original image and the pattern images, are formed on the continuous sheet of paper.

The fixing section 16 has a flash fixing device 52, an idle roller 54A, an idle roller 54B, an idle roller 54C, and sheet discharging rollers 56. The idle roller 54A, the idle roller 54B, and the idle roller 54C convey the continuous sheet of paper P which is trained thereon, with the obverse and reverse of the continuous sheet of paper P inverted. The flash fixing device 52 irradiates infrared rays onto the color image forming surface of the continuous sheet of paper P. The unfixed toner image on the continuous sheet of paper P is heated and fused by the irradiation of the infrared rays, and thereafter, coagulating. The color image is thereby fixed on the continuous sheet of paper P. The continuous sheet of paper P, which has passed by the flash fixing device 52, is conveyed to the sheet discharging section 17, is again conveyed to the fixing section 16 via an idle roller 59A and an idle roller 59C, and thereafter, is discharged to the exterior of the device by the sheet discharging rollers 56.

In the present embodiment, a case is described in which the printing section 12Y which forms the Y color images (the original image and the pattern image), the printing section 12M which forms the M color images, the printing section 12C which forms the C color images, and the printing section 12K which forms the K color images, are lined-up in that order along the conveying direction of the continuous sheet of paper, from the conveying direction upstream side toward the downstream side. However, the arrangement of the printing section 12Y, the printing section 12M, the printing section 12C, and the printing section 12K is not limited to this form.

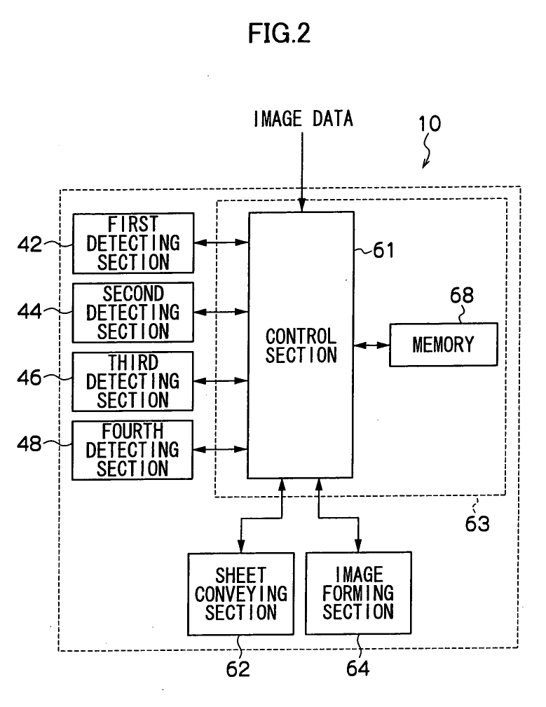

As shown in FIG. 2, the image forming device 10 is structured so as to include a main controller 63, a sheet conveying section 62, an image forming section 64, a first detecting section (detector) 42, a second detecting section (detector) 44, a third detecting section (detector) 46, and a fourth detecting section (detector) 48. The main controller 63 is structured so as to include a control section 61 and a memory 68. The control section 61 is connected, so as to be able to transmit and receive data and commands, to the memory 68, the first detecting section 42, the second detecting section 44, the third detecting section 46, the fourth detecting section 48, the sheet conveying section 62, and the image forming section 64. The control section 61 controls the image forming device 10 overall, and mainly controls the sheet conveying section 62 and the image forming section 64 such that, on the basis of the image data of the inputted original image, the original images of the respective colors are transferred onto the continuous sheet of paper in a superposed manner and a color image is formed on the continuous sheet of paper P. The sheet conveying section 62 is structured to include a driving section which respectively drives the various types of conveying portions relating to the conveying of the continuous sheet of paper, such as the following which were described above and are illustrated in FIG. 1: the idle roller 19D, the conveying roller 18, the idle roller 19C, the transfer roller 24Y, the two guide rollers 40Y, the transfer roller 24M, the two guide rollers 40M, the transfer roller 24C, the two guide rollers 40C, the transfer roller 24K, the two guide rollers 40K, the idle roller 54A, the idle roller 54B, the idle roller 54C, the sheet discharging rollers 56, and the like. The sheet conveying section 62 conveys the continuous sheet of paper at a predetermined speed in the conveying direction, along the conveying path of the continuous sheet of paper. The image forming section 64 is structured so as to include the above-described printing section 12Y, printing section 12M, printing section 12C, and printing section 12K. The memory 68 stores in advance information, which expresses positional offset amounts of the respective color images which will be described in detail later, as well as various types of data and the like.

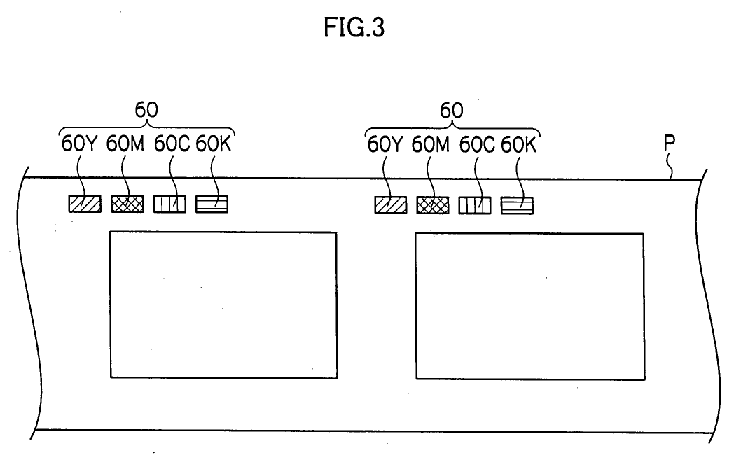

In the image forming device 10 of the present embodiment, in order to compute the positional offset amounts of the images of the respective colors, electrostatic latent images are formed on the image carrier 22Y, the image carrier 22M, the image carrier 22C, and the image carrier 22K by outputting image data, which is for each color and which is based on the image data of the original image, to the LED head 32Y, the LED head 32M, the LED head 32C, and the LED head 32K respectively, and a pattern image 60Y, a pattern image 60M, a pattern image 60C, and a pattern image 60K, which serve as pattern images of the respective colors and which are shown in FIG. 3, are formed on the continuous sheet of paper P by the printing section 12Y, the printing section 12M, the printing section 12C, and the printing section 12K. When the pattern image 60Y, the pattern image 60M, the pattern image 60C, and the pattern image 60K are in ideal states in which no positional offset has arisen, they are formed so as to be separated by predetermined intervals in the conveying direction of the continuous sheet of paper P. The pattern image 60Y, the pattern image 60M, the pattern image 60C, and the pattern image 60K are detected by the first detecting section 42, the second detecting section 44, the third detecting section 46 and the fourth detecting section 48 which are provided at the conveying direction downstream sides of the image carrier 22Y, the image carrier 22M, the image carrier 22C and the image carrier 22K respectively (see FIG. 1).

The first detecting section 42 is disposed at a position such that the distance, which is from the position at which the first detecting section 42 is disposed to the transfer position of transferring, onto the continuous sheet of paper, the electrostatic latent image which is formed on the image carrier 22M which is closest to the first detecting section 42 at the conveying direction downstream side thereof, is greater than the distance, which is from the position of the image carrier 22M where formation of the electrostatic latent image onto the image carrier 22M by the LED head 32M starts (hereinafter called “electrostatic latent image formation start position”) to the transfer position. Further, in the same way as the first detecting section 42, the second detecting section 44 is disposed at a position such that the distance, which is from the position at which the second detecting section 44 is disposed to the transfer position of transferring, onto the continuous sheet of paper, the electrostatic latent image which is formed on the image carrier 22C which is closest to the second detecting section 44 at the conveying direction downstream side thereof, is greater than the distance, which is from the position of the image carrier 22C where formation of the electrostatic latent image onto the image carrier 22C by the LED head 32C starts (hereinafter called the “electrostatic latent image formation start position”) to the transfer position. Moreover, in the same way as the first detecting section 42, the third detecting section 46 is disposed at a position such that the distance, which is from the position at which the third detecting section 46 is disposed to the transfer position of transferring, onto the continuous sheet of paper, the electrostatic latent image which is formed on the image carrier 22K which is closest to the third detecting section 46 at the conveying direction downstream side thereof, is greater than the distance, which is from the position of the image carrier 22K where formation of the electrostatic latent image onto the image carrier 22K by the LED head 32K starts (hereinafter called the “electrostatic latent image formation start position”) to the transfer position.

In the present embodiment, the first detecting section 42 detects the Y color pattern image. The second detecting section 44 detects the Y color pattern image and the M color pattern image. The third detecting section 46 detects the Y color pattern image and the C color pattern image. The fourth detecting section 48 detects the Y color pattern image and the K color pattern image.

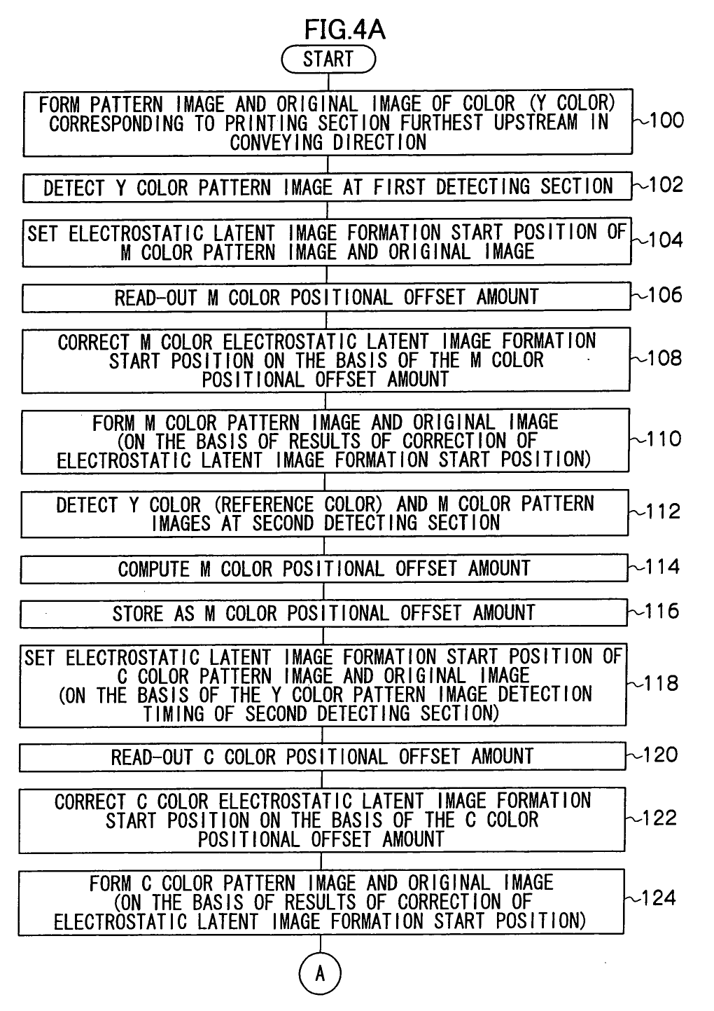

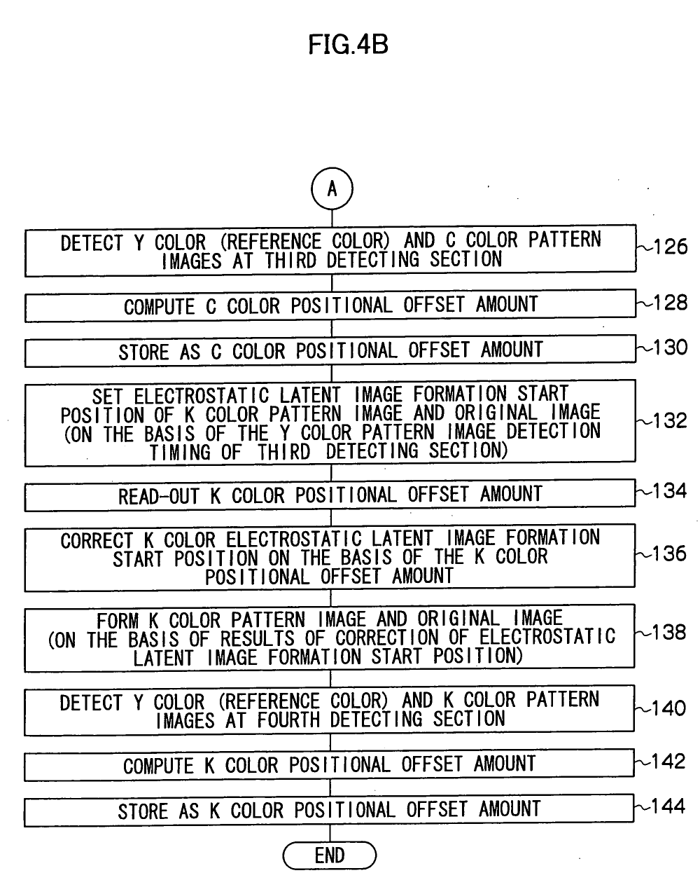

Next, the processing executed at the control section 61 will be described with reference to FIGS. 4A and 4B.

When the power is turned on by a power switch (not shown) of the image forming device 10 and image data of an original image is received from the exterior, the processing routine shown in FIGS. 4A and 4B is carried out for each page of the original image.

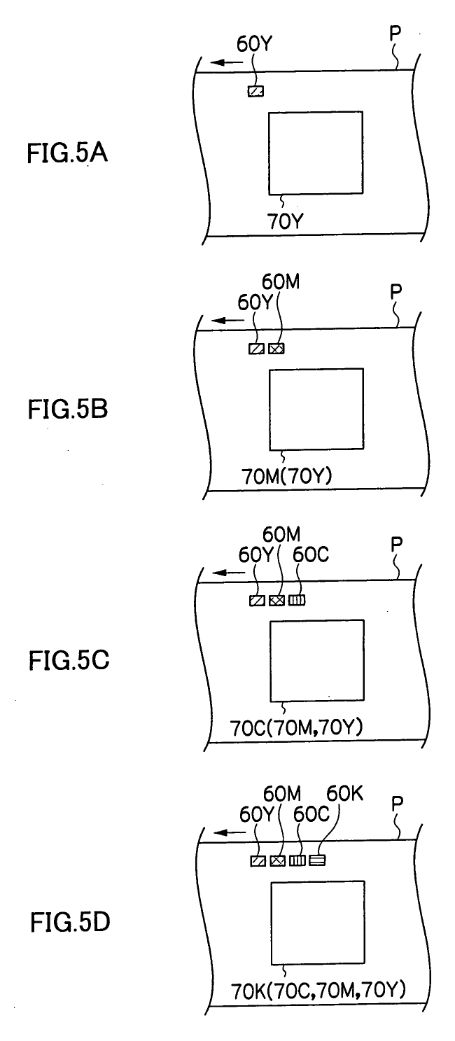

In step 100, the pattern image and the original image of the color (Y color) corresponding to the printing section 12Y which is disposed the furthest upstream in the conveying direction, are formed. Due to the processing of step 100, the pattern image 60Y and an original image 70Y are formed on the continuous sheet of paper P as shown in FIG. 5A. In the present embodiment, the pattern image 60Y is formed at the downstream side, in the conveying direction of the continuous sheet of paper, of the original image 70Y.

In next step 102, the pattern image 60Y formed on the continuous sheet of paper P is detected by the first detecting section 42 as a reference color. In subsequent step 104, on the basis of the detection timing of the detected pattern image 60Y of the reference color, the electrostatic latent image formation start position of the pattern image 60M and an original image 70M of the M color, which are to be formed by the printing section 12M which is adjacent to the printing section 12Y at the conveying direction downstream side thereof, is set. It suffices to determine the electrostatic latent image formation start position such that the original image 70M is formed at a position at which it is superposed on the original image 70Y formed on the continuous sheet of paper P, on the basis of the detection timing of the pattern image 60Y of the reference color, and, for example, the following information which are stored in advance in the memory 68: the distance from the electrostatic latent image formation start position on the image carrier 22M by the LED head 32M to the transfer position onto the continuous sheet of paper P, the distance from the first detecting section 42 to the transfer position of the image carrier 22M which is closest to the first detecting section 42, the relationship between the rotational speed of the image carrier 22M and the conveying speed of the continuous sheet of paper P, and the positional relationship between the original image 70Y and the pattern image 60Y of the reference color which are formed on continuous sheet of paper P.

In next step 106, the positional offset amount of the M color pattern image 60M, which is stored in the memory 68, is read-out. The positional offset amount of the pattern image 60M is the positional offset amount which was computed on the basis of the results of formation at the time of forming the pattern image 60M and the original image 70M of the previous time, i.e., the previous page, onto the continuous sheet of paper P.

In subsequent step 108, on the basis of positional offset amount of the M color pattern image 60M which was read-out in above step 106, the electrostatic latent image formation start position of the pattern image 60M and the original image 70M, which was set in above step 104, is corrected such that the positional offset is eliminated.

In step 110, on the basis of the electrostatic latent image formation start position which was corrected by the processing of above step 108, the LED head 32M of the printing section 12M is controlled such that the original image 70M and the pattern image 60M are formed on the image carrier 22M from this electrostatic latent image formation start position. In this way, the pattern image 60M is formed on the continuous sheet of paper P, and the original image 70M is formed at a position so as to be superposed on the original image 70Y. Due to the processing of step 110, as shown in FIG. 5B, the pattern image 60M is formed on the continuous sheet of paper P, and the original image 70M is formed at a position so as to be superposed on the original image 70Y.

In next step 112, the reference color pattern image 60Y and the M color pattern image 60M, which are formed on the continuous sheet of paper P, are detected by the second detecting section 44.

In step 114, on the basis of the detection timings of the reference color pattern image 60Y and the M color pattern image 60M which were detected in above step 112, the offset amount of the M color pattern image 60M is computed. Specifically, the computation of the offset amount is carried out as follows for example: the distance to the pattern image 60M, with the pattern image 60Y as the reference, is computed from conveying speed of the continuous sheet of paper P and the period of time from the time that the reference color pattern image 60Y is sensed to the time when the pattern image 60M is sensed, and the difference between this distance and the distance when there is no positional offset is computed as the positional offset amount of the pattern image 60M.

In next step 116, the positional offset amount of the M color pattern image 60M, which was computed in above step 114, is stored in the memory 68. As stated in above step 106, at the time of forming the M color original image 70M the next time, i.e., the M color original image 70M of the next page, the positional offset amount of the M color pattern image 60M stored in the memory 68 is used as the correction amount for correcting the electrostatic latent image formation start position which is set at the time of forming the original image 70M of the next page.

In next step 118, on the basis of the detection timing of the pattern image 60Y of the reference color detected in step 112, the electrostatic latent image formation start position of the pattern image 60C and an original image 70C of the C color, which are to be formed by the printing section 12C which is adjacent to the printing section 12M at the conveying direction downstream side thereof, is set in substantially the same way as in the processing of step 104.

In subsequent step 120, the positional offset amount of the C color pattern image 60C, which was computed on the basis of the results of formation at the time of forming the pattern image 60C and the original image 70C of the previous page onto the continuous sheet of paper P, is read-out from the memory 68.

In next step 122, in substantially the same way as in the processing of above step 108, the electrostatic latent image formation start position of the pattern image 60C and the original image 70C, which was set in above step 118, is corrected on the basis of positional offset amount of the C color pattern image 60C which was read-out in above step 120.

In subsequent step 124, on the basis of the electrostatic latent image formation start position which was corrected by the processing of above step 122, the LED head 32C of the printing section 12C is controlled such that the original image 70C and the pattern image 60C are formed on the image carrier 22C from this electrostatic latent image formation start position. In this way, the pattern image 60C is formed on the continuous sheet of paper P, and the original image 70C is formed at a position so as to be superposed on the original image 70Y and the original image 70M. Due to the processing of step 124, as shown in FIG. 5C, the pattern image 60C is formed on the continuous sheet of paper P, and the original image 70C is formed at a position so as to be superposed on the original image 70Y and the original image 70M.

In next step 126, the reference color pattern image 60Y and the C color pattern image 60C, which are formed on the continuous sheet of paper P, are detected by the third detecting section 46.

In step 128, on the basis of the detection timings of the reference color pattern image 60Y and the C color pattern image 60C which were detected in above step 126, processing similar to the processing of step 114 is carried out, and the offset amount of the C color pattern image 60C is computed.

In next step 130, the positional offset amount of the C color pattern image 60C, which was computed in above step 128, is stored in the memory 68. As stated in above step 120, at the time of forming the C color original image 70C the next time, i.e., the C color original image 70C of the next page, the positional offset amount of the C color pattern image 60C stored in the memory 68 is used as the correction amount for correcting the electrostatic latent image formation start position which is set at the time of forming the original image 70C of the next page.

In next step 132, on the basis of the detection timing of the pattern image 60Y of the reference color detected in step 126, the electrostatic latent image formation start position of the pattern image 60K and an original image 70K of the K color, which are to be formed by the printing section 12K which is adjacent to the printing section 12C at the conveying direction downstream side thereof, is set in substantially the same way as in the processing of step 104.

In subsequent step 134, the positional offset amount of the K color pattern image 60K, which was computed on the basis of the results of formation at the time of forming the pattern image 60K and the original image 70K of the previous page onto the continuous sheet of paper P, is read-out from the memory 68.

In next step 136, in substantially the same way as in the processing of above step 108, the electrostatic latent image formation start position of the pattern image 60K and the original image 70K, which was set in above step 132, is corrected on the basis of positional offset amount of the K color pattern image 60K which was read-out in above step 134.

In subsequent step 138, on the basis of the electrostatic latent image formation start position which was corrected by the processing of above step 136, the LED head 32K of the printing section 12K is controlled such that the original image 70K and the pattern image 60K are formed on the image carrier 22K from this electrostatic latent image formation start position. In this way, the pattern image 60K is formed on the continuous sheet of paper P, and the original image 70K is formed at a position so as to be superposed on the original image 70Y, the original image 70M, and the original image 70C. Due to the processing of step 138, as shown in FIG. 5D, the pattern image 60K is formed on the continuous sheet of paper P, and the original image 70K is formed at a position so as to be superposed on the original image 70Y, the original image 70M, and the original image 70C, which are formed in a superposed manner.

In next step 140, the reference color pattern image 60Y and the K color pattern image 60K, which are formed on the continuous sheet of paper P, are detected by the fourth detecting section 48 which is provided the furthest downstream, in the conveying direction of the continuous sheet of paper, among the plural detecting sections.

In step 142, on the basis of the detection timings of the reference color pattern image 60Y and the K color pattern image 60K which were detected in above step 140, processing similar to the processing of step 114 is carried out, and the offset amount of the K color pattern image 60K is computed.

In next step 144, the positional offset amount of the K color pattern image 60K, which was computed in above step 142, is stored in the memory 68, and thereafter, the present routine ends. At the time of forming the K color original image 70K of the next page, the positional offset amount of the K color pattern image 60K stored in the memory 68 is used as the correction amount for correcting the electrostatic latent image formation start position which is set at the time of forming the original image 70K of the next page.

As described above, in accordance with the image forming device of the present embodiment, the pattern image of the reference color formed by the upstream-most printing section 12Y is detected by the detecting sections which are closest to the image carriers at the conveying direction upstream sides thereof. On the basis of the results of detection, the electrostatic latent image formation start positions of the original images and the pattern images onto the image carriers which are closest to the detecting sections at the conveying direction downstream sides thereof, are set. The set electrostatic latent image formation start positions are corrected on the basis of the positional offset amounts of the pattern images computed at the time of forming the pattern images onto the continuous sheet of paper the previous time.

Therefore, by determining the electrostatic latent image formation start position of each image carrier on the basis of the detection timing of the pattern image of the reference color, it is possible to correct positional offset caused by fluctuations in the conveying speed of the continuous sheet of paper which are due to elongation of or errors in the conveying of the continuous sheet of paper. Further, by correcting this set electrostatic latent image formation start position on the basis of the positional offset amount of the pattern image which was computed at the time of forming the pattern image onto the continuous sheet of paper the previous time, it is possible to correct positional offset which is due to fluctuations in the rotational speed of the image carrier with respect to the conveying speed of the continuous sheet of paper.

Accordingly, both positional offset due to fluctuations in the conveying speed of the continuous sheet of paper, and positional offset due to fluctuations in the rotational speeds of the respective image carriers with respect to the conveying speed of the continuous sheet of paper, can be corrected, and the positional offsets of the original images can be corrected accurately.

In order to determine the positional offset amount of the image formed at the corresponding image carrier, each of the sensing units senses only the two pattern images, i.e., the pattern image of the reference color and the pattern image of the corresponding color. Therefore, the pattern images can be detected efficiently.

Each of the detecting sections is disposed at a position such that the distance, which is from the position at which the detecting section is disposed to the transfer position of transferring, onto the continuous sheet of paper, the electrostatic latent image which is formed on the image carrier which is closest to the detecting section at the conveying direction downstream side thereof, is greater than the distance, which is from the electrostatic latent image formation start position, where formation of the electrostatic latent image onto the image carrier by the LED head corresponding to that image carrier starts, to the transfer position. By using the results of detection of the detecting section, the electrostatic latent image can be formed on the image carrier from the electrostatic latent image formation start position which has been set efficiently, without causing a delay in the timing of the start of exposure onto the image carrier by the LED head.

Note that, in the present embodiment, explanation has been given of a case in which the printing section 12Y, the printing section 12M, the printing section 12C, and the printing section 12K are lined-up in that order from the conveying direction upstream side of the continuous sheet of paper P toward the downstream side. However, the present invention is not limited to such an arrangement. For example, the printing section 12C, the printing section 12M, the printing section 12Y and the printing section 12K may be lined-up in that order from the conveying direction upstream side toward the downstream side. In this case, it suffices to carry out processings which are similar to the processings shown in above-described FIGS. 4A and 4B, such that the pattern image formation and original image formation processings are carried out in order from the printing section 12C, which is provided the furthest upstream in the conveying direction, to the printing section 12K which is provided the furthest downstream in the conveying direction.

It suffices for there to be plural printing sections, but the printing sections are not limited to the printing sections of the four colors as in the present embodiment.

As described above, an image forming device of a first aspect of the present invention includes: a plurality of image carriers lined-up along a conveying direction of a continuous sheet of paper which is conveyed; a plurality of latent image forming units forming electrostatic latent images of images, which include a pattern image and an original image, on the image carriers; a plurality of developing units developing the electrostatic latent images formed on the image carriers, by developing materials of different colors; a plurality of transfer units transferring images of different colors, which have been developed at the developing units, onto the continuous sheet of paper; a plurality of detectors disposed at conveying direction downstream sides of the image carriers respectively, and detecting the pattern images of the different colors which have been transferred by the transfer units; a computer which, by using as a reference color the color of the developing material which develops one of the pattern images detected by the detectors, computes positional offset amounts of pattern images developed in colors other than the reference color; and a controller which, on the basis of timings at which the pattern images are detected by the detectors which are positioned at conveying direction upstream sides of the image carriers respectively, determines electrostatic latent image formation start positions, on the image carriers, of the original images, and which, on the basis of positional offset amounts computed when transferring pattern images a previous time, corrects the electrostatic latent image formation start positions, and which controls the latent image forming units such that the electrostatic latent images of the original images are formed on the image carriers from corrected electrostatic latent image formation start positions.

Each of the plurality of latent image forming units of the image forming device of the present invention forms an electrostatic latent image, which includes a pattern image and an original image (a main image), on the corresponding one of the plurality of image carriers which are lined-up along the conveying direction of the continuous sheet of paper, i.e., a web-like recording medium, which is being conveyed. The electrostatic latent images formed on the image carriers are developed by developing materials of respectively different colors by the developing units. The transfer units transfer, on the continuous sheet of paper, the images of the different colors which were developed by the developing units. The detectors detect the pattern images of the different colors, which were transferred by the transfer units. The computer computes the positional offset amounts of the pattern images of the colors other than the color of the pattern image, which positional offset amounts are based on the pattern image of the reference color among the pattern images detected by the detectors. The controller sets electrostatic latent image formation start positions of the original images of the image carriers on the basis of the timings at which the pattern images are detected by the detectors positioned at the conveying direction upstream sides of the image carriers. The controller corrects the electrostatic latent image formation start positions on the basis of the positional offset amounts of the pattern images which were computed by the computer at the time when the pattern images were transferred the previous time. The controller controls the latent image forming units such that the electrostatic latent images of the original images are formed on the image carriers from the corrected electrostatic latent image formation start positions. Due to the control of the controller, the latent image forming units form the original images on the corresponding image carriers, from the corrected positions which are obtained by correcting the electrostatic latent image formation start positions which were set on the basis of the timings at which the pattern images were detected.

In this way, the electrostatic latent image formation start positions of the original images at the image carriers are set on the basis of the timings at which the pattern images are detected by the detectors positioned at the conveying direction upstream sides of the image carriers. Therefore, it is possible to correct positional offset of the original images due to fluctuations in the conveying speed of the continuous sheet of paper which are caused by elongation of and fluctuations in the conveying of the continuous sheet of paper. Further, the electrostatic latent image formation start positions which are set are corrected on the basis of the positional offset amounts of the pattern images, which positional offset amounts were computed by the computer at the time when the pattern images were transferred the previous time. Therefore, it is possible to correct positional offset of the original images due to fluctuations in the rotational speeds of the image carriers with respect to the conveying speed of the continuous sheet of paper.

Accordingly, both positional offset of the original images due to fluctuations in the conveying speed of the continuous sheet of paper, and positional offset of the original images due to fluctuations in the rotational speeds of the image carriers with respect to the conveying speed of the continuous sheet of paper, can be corrected, and positional offset of the original images can be corrected accurately.

An image forming device of a second aspect of the present invention includes: a plurality of image carriers lined-up along a conveying direction of a recording medium which is conveyed; a plurality of latent image forming units forming, on the image carriers, electrostatic latent images for images including a pattern image and a main image; a plurality of developing units forming an image of a different hue respectively on each of the image carriers, by developing the electrostatic latent images formed on the image carriers, by developing materials of respectively different hues including a reference color; a plurality of transfer units transferring, onto the recording medium, the images which have been developed; a plurality of detectors disposed at conveying direction downstream sides of the image carriers respectively, and detecting pattern images which have been transferred; a controller determining start positions of electrostatic latent image formation of the images on the image carriers, and on the basis of timings at which the pattern image of the reference color is detected by the detectors, among the plurality of detectors, which are positioned at conveying direction upstream sides respectively of the image carriers on which images of colors other than the reference color are formed, the controller determining the start positions of the electrostatic latent image formation of the image carriers at which the images of colors other than the reference color are formed; and a computer which, on the basis of results of detection of the pattern images which have been transferred, computes offset amounts of the pattern images from positions on the recording medium corresponding to the start positions, wherein, on the basis of the offset amounts in an image formation which was conducted precedingly, the controller corrects the start positions of the electrostatic latent image formation, and controls the latent image forming units on the basis of the start positions which have been corrected.

An image forming device of a third aspect of the present invention includes: first and second image printing units which are lined-up along a conveying direction of a recording medium which is conveyed, and which are for forming images of different hues, which images include a pattern image and a main image, on the recording medium; detectors disposed at conveying direction downstream sides of the first and second image printing units respectively, and detecting the pattern images formed on the recording medium; a controller controlling starting of image forming operations of the first and the second image printing units, the controller controlling the image forming operation of the second image printing unit on the basis of a timing at which the pattern image formed by the first image printing unit is detected by the detector positioned at a conveying direction upstream side of the second image printing unit; and a computer which, on the basis of results of detection of the pattern images formed on the recording medium by the first and second image printing units, computes an offset amount of the pattern image formed by the second image printing unit, from a prearranged position, wherein, on the basis of the offset amount in an image forming operation which was carried out precedingly, the controller effects control so as to correct the starting of the image forming operation by the second image printing unit.

As described in the above embodiment, in accordance with the image forming device of the present invention, the electrostatic latent image formation start positions, of the original images, on the image carriers are respectively determined on the basis of the timings at which the pattern images are respectively detected by the detectors respectively positioned at the conveying direction upstream sides of the image carriers, and the electrostatic latent image formation start positions are respectively corrected on the basis of respectively corresponding positional offset amounts of the pattern images which were computed by the computer at the time of transfer of the pattern images the previous time. Therefore, the image forming device of the present invention has the effects that positional offset of the original images due to fluctuations in the conveying speed of the continuous sheet of paper can be corrected, and positional offset of the original images due to fluctuations in the rotational speeds of the image carriers with respect to the conveying speed of the continuous sheet of paper can be corrected, and positional offset of the original images can be correctly accurately.

Further, a structure is possible in which the controller can control the latent image forming units such that the electrostatic latent image formation start positions of the image carriers are determined on the basis of the timings at which the pattern image of the reference color is detected. Therefore, electrostatic latent image formation start positions can be set at the respective image carriers based on the same pattern image, and the electrostatic latent image formation start positions can be set accurately.

The reference color can be the color of the developing material which develops at the developing unit which is positioned furthest upstream in the conveying direction. Therefore, the computer can compute the positional offset amounts of the pattern images of the colors other than the reference color, which positional offset amounts are based on the same pattern image which is that of the reference color. Therefore, the positional offset amounts can be computed accurately.

Further, distances, which are from positions where the detectors are disposed to transfer positions of the images onto the continuous sheet of paper on the image carriers closest to the detectors at conveying direction downstream sides thereof, may be greater than distances, which are from positions at which formation of the electrostatic latent images onto the image carriers by the latent image forming units is started, to the transfer positions.

In accordance with this structure, the occurrence of a time loss can be suppressed and the positional offset amount can be corrected efficiently.

What is claimed is:

1. An image forming device comprising:
a plurality of image carriers lined-up along a conveying direction of a continuous sheet of paper;
a plurality of latent image forming units that form electrostatic latent images which include a pattern image and an original image, on the image carriers;
a plurality of developing units that develop the electrostatic latent images formed on the image carriers, by developing materials of different colors;
a plurality of transfer units that transfer images of different colors, which have been developed at the developing units, onto the continuous sheet of paper;
a plurality of detectors that detect the pattern images of the different colors which have been transferred by the transfer units, the detectors being disposed at conveying direction downstream sides of the image carriers respectively;
a computer that computes positional offset amounts of the pattern images developed in colors other than a reference color, the reference color being the color of the developing material which develops one of the pattern images detected by the detectors; and
a controller that, on the basis of timings at which the pattern images are detected by the detectors which are positioned at conveying direction upstream sides of the image carriers respectively, determines positions of starting the electrostatic latent image formation of the original images, on the basis of positional offset amounts computed at a previous time, corrects the positions of starting the electrostatic latent image formation, and controls the latent image forming units such that the electrostatic latent images of the original images are formed on the image carriers from the corrected positions.

2. The image forming device according to claim 1, wherein the timings are timings at which the pattern image of the reference color is detected.

3. The image forming device according to claim 1, wherein the reference color is the color of the developing material which develops at the developing unit which is positioned furthest upstream in the conveying direction.

4. The image forming device according to claim 1, wherein distances, which are from positions where the detectors are disposed to transfer positions of the images onto the continuous sheet of paper on the image carriers closest to the detectors at conveying direction downstream sides thereof, are greater than distances, which are from positions at which formation of the electrostatic latent images onto the image carriers by the latent image forming units is started to the transfer positions.

5. The image forming device according to claim 1, further comprising a storage unit that stores the positional offset amounts.

6. An image forming device comprising:
a plurality of image carriers lined-up along a conveying direction of a recording medium;
a plurality of latent image forming units that form, on the image carriers, electrostatic latent images for images including a pattern image and a main image;
a plurality of developing units that form an image of a different hue respectively on each of the image carriers, by developing the electrostatic latent images formed on the image carriers, by developing materials of respectively different hues including a reference color;
a plurality of transfer units that transfer, onto the recording medium, the images which have been developed;
a plurality of detectors that detect pattern images which have been transferred, the detectors being disposed at conveying direction downstream sides of the image carriers respectively;
a controller that determines start positions of electrostatic latent image formation of the images on the image carriers, and on the basis of timings at which the pattern image of the reference color is detected by the detectors, among the plurality of detectors, which are positioned at conveying direction upstream sides respectively of the image carriers on which images of colors other than the reference color are formed, the controller that determines the start positions of the electrostatic latent image formation of the image carriers at which the images of colors other than the reference color are formed; and
a computer that, on the basis of results of detection of the pattern images which have been transferred, computes offset amounts of the pattern images from positions on the recording medium corresponding to the start positions,
wherein, on the basis of the offset amounts in an image formation which was conducted precedingly, the controller corrects the start positions of the electrostatic latent image formation, and controls the latent image forming units on the basis of the start positions which have been corrected.

7. The image forming device according to claim 6, further comprising a storage unit storing the offset amounts.

8. The image forming device according to claim 6, wherein the reference color is the color of the developing material which develops at the developing unit which is positioned furthest upstream in the conveying direction.

9. The image forming device according to claim 6, wherein distances, which are from the detectors to transfer positions onto the recording medium of the images on the image carriers closest to the detectors at conveying direction downstream sides thereof respectively, are greater than distances, which are from the start positions of the electrostatic latent image formation onto the image carriers to the transfer positions.

10. The image forming device according to claim 6, wherein the recording medium is a web-like paper.

11. An image forming device comprising:
first and second image printing units that are lined-up along a conveying direction of a recording medium, and form images of different hues on the recording medium, the images having a pattern image and a main image;
a plurality of detectors that detects the pattern images formed on the recording medium, the detectors being disposed at conveying direction downstream sides of the first and second image printing units respectively;
a controller that controls starting of image forming operations of the first and the second image printing units, the controller that controls the image forming operation of the second image printing unit on the basis of a timing at which the pattern image formed by the first image printing unit is detected by the detector positioned at a conveying direction upstream side of the second image printing unit; and
a computer that, on the basis of results of detection of the pattern images formed on the recording medium by the first and second image printing units, computes an offset amount of the pattern image formed by the second image printing unit, from a prearranged position,
wherein, on the basis of the offset amount in an image forming operation which was carried out precedingly, the controller effects control so as to correct the starting of the image forming operation by the second image printing unit.

12. The image forming device according to claim 11, further comprising a storage unit storing the offset amount.

13. The image forming device according to claim 11, wherein the recording medium is a web-like paper.
